(19) United States
(12) Patent Application Publication
(10) Pub. No.: US 2016/0309014 A1
(43) Pub. Date: Oct. 20, 2016

(54) TEXT RESPONSE SYSTEM

(71) Applicant: Charles Brown, Bowman, SC (US)

(72) Inventor: Charles Brown, Bowman, SC (US)

(21) Appl. No.: 14/687,374

(22) Filed: Apr. 15, 2015

(51) Int. Cl. H04M 1/725; H04W 4/14

(52) U.S. Cl. CPC H04M 1/72527; H04M 1/72577; H04W 4/14

(57) ABSTRACT

A text response system for sending a pre-determined text message while a user is driving a vehicle includes an electronic communication device that may send and receive text messages. A button is attached to the electronic communication device wherein the button may be manipulated by a user when the user is driving a vehicle. The electronic communication device sends the pre-determined text message as a reply to an incoming text message when the button is manipulated wherein the button prevents the user from being distracted while driving the vehicle.

### BACKGROUND OF THE DISCLOSURE

1. Field of the Disclosure

The disclosure relates to text response devices and more particularly pertains to a new text response device for sending a pre-determined text message while a user is driving a vehicle.

2. Summary of the Disclosure

An embodiment of the disclosure meets the needs presented above by generally comprising an electronic communication device that may send and receive text messages. A button is attached to the electronic communication device wherein the button may be manipulated by a user when the user is driving a vehicle. The electronic communication device sends the pre-determined text message as a reply to an incoming text message when the button is manipulated wherein the button prevents the user from being distracted while driving the vehicle.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a text response system according to an embodiment of the disclosure.

FIG. 2 is a left side view of an embodiment of the disclosure.

FIG. 3 is a front view of an embodiment of the disclosure.

FIG. 4 is a perspective in-use view of an embodiment of the disclosure.

FIG. 5 is a schematic view of an embodiment of the disclosure.

### DESCRIPTION OF THE PREFERRED EMBODIMENT

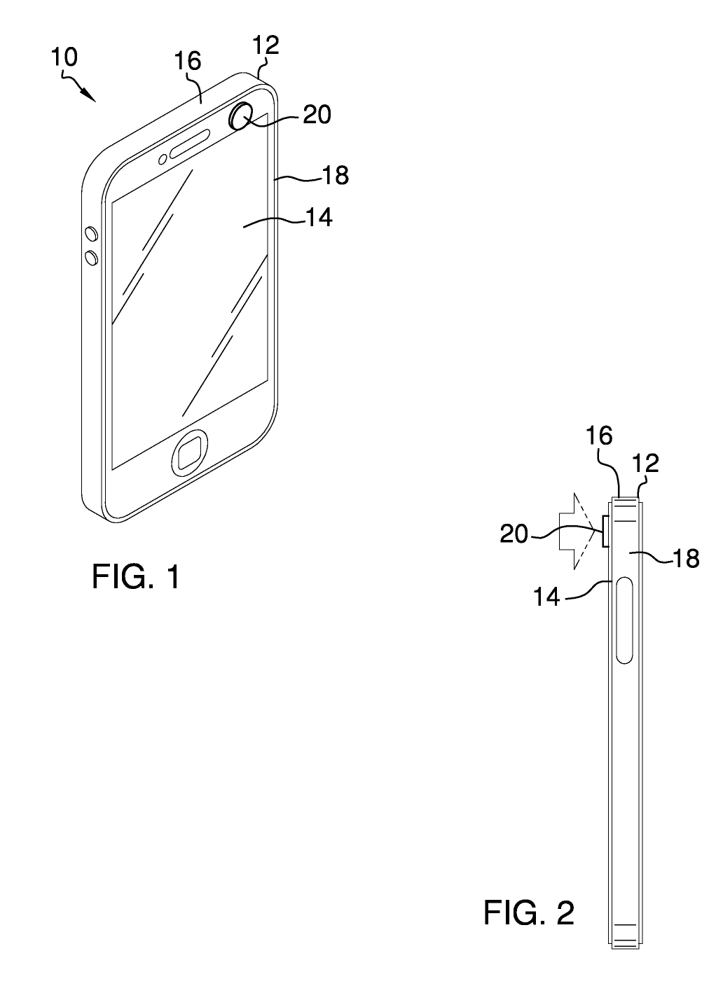

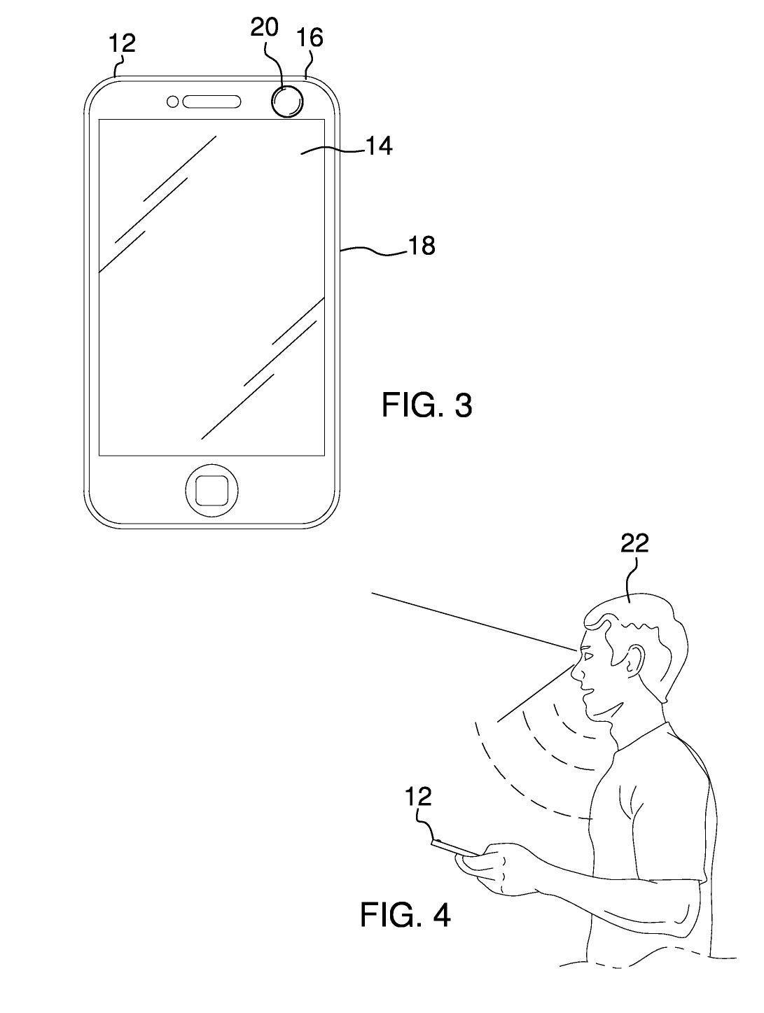

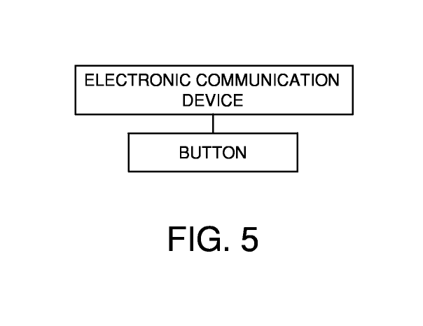

With reference now to the drawings, and in particular to FIGS. 1 through 5 thereof, a new text response device embodying the principles and concepts of an embodiment of the disclosure and generally designated by the reference numeral 10 will be described.

As best illustrated in FIGS. 1 through 5, the text response system 10 generally comprises an electronic communication device 12 that may send and receive text messages. The electronic communication device 12 may comprise a smart phone that is in electrical communication with an extrinsic communications network. The electronic communication device 12 has a front side 14, a top side 16 and a first lateral side 18. The electronic communication device 12 contains a pre-determined text response. The pre-determined text response may comprise the words “I can't respond right now. I am driving. I will contact you when I can.”.

A button 20 is attached to the electronic communication device 12 and the button 20 is positioned on the front side 14. Thus, the button 20 may be manipulated by a user 22 when the user 22 is driving a vehicle. The button 20 is positioned adjacent to intersection of the top side 16 and the first lateral side 18. Additionally, the button 20 extends forwardly from the front side 14 thereby facilitating the user 22 to find the button 20 without the user 22 having to look away from the road. The button 20 is electrically coupled to the electronic communication device 12 such that the electronic communication device 12 sends the pre-determined text message as a reply to an incoming text message when the button 20 is manipulated. Thus, the button 20 allows the user 22 to respond to a text message without being distracted while driving.

In use, the user 22 manipulates the button 20 to respond to a text message that is received while the user 22 is driving. The button 20 actuates the electronic communication device 12 to send to pre-determined text message as a reply. Thus, the user 22 is not distracted by texting while the user 22 is driving.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A text response device for sending a pre-determined text message while a user is driving a vehicle, said device comprising:
an electronic communication device configured to send and receive text messages, said electronic communication device having a front side, a top side and a first lateral side; and
a button being attached to said electronic communication device wherein said button is configured to be manipulated by a user when the user is driving a vehicle, said button having a planar face positioned in outwardly spaced and parallel relationship to said front side of said electronic communication device wherein said button is configured for facilitating tactile location of said button on said electronic communication device, said electronic communication device sending said pre-determined text message as a reply to an incoming text message when said button is manipulated wherein said button is configured to prevent the user from being distracted while driving the vehicle.

2. The text response device according to claim 1, further comprising said electronic communication device containing a pre-determined text response.

3. The text response device according to claim 1, further comprising:
said button being positioned adjacent to intersection of said top side and said first lateral side, said button being electrically coupled to said electronic communication device.

4. A text response device for sending a pre-determined text message while a user is driving a vehicle, said device comprising:
an electronic communication device configured to send and receive text messages, said electronic communication device having a front side, a top side and a first lateral side, said electronic communication device containing a pre-determined text response; and
a button being attached to said electronic communication device, said button being positioned on said front side wherein said button is configured to be manipulated by a user when the user is driving a vehicle, said button having a planar face positioned in outwardly spaced and parallel relationship to said front side of said electronic communication device wherein said button is configured for facilitating tactile location of said button on said electronic communication device, said button being positioned adjacent to intersection of said top side and said first lateral side, said button being electrically coupled to said electronic communication device such that said electronic communication device sends said pre-determined text message as a reply to an incoming text message when said button is manipulated wherein said button is configured to prevent the user from being distracted while driving the vehicle.
